(19) United States
(12) Patent Application Publication
(10) Pub. No.: US 2012/0084379 A1
(43) Pub. Date: Apr. 5, 2012

(54) METHOD AND APPARATUS FOR CHECKING AND SYNCHRONIZING DATA BLOCK IN DISTRIBUTED FILE SYSTEM

(75) Inventors: Jie Peng, Guangdong Province (CN); Ning Cheng, Guangdong Province (CN); Chong Wang, Guangdong Province (CN); Jianbo Xia, Guangdong Province (CN); Bo Zhang, Guangdong Province (CN)

(73) Assignee: ZTE CORPORATION, Shenzhen City, Guangdong Province (CN)

(21) Appl. No.: 13/376,622

(22) PCT Filed: Dec. 8, 2009
(86) PCT No.: PCT/CN2009/075391

§ 371 Date: Dec. 7, 2011

(30) Foreign Application Priority Data
Jun. 9, 2009 (CN) 200910108051.5

(51) Int. Cl. G06F 15/16

(52) U.S. Cl. 709/208

(57) ABSTRACT

A method and apparatus for checking and synchronizing data blocks in a distributed file system are provided. The distributed file system includes a metadata server, data block servers and a storage medium; the metadata server specifies one of the data block servers in the same group as a master data block server, while takes the others as slave data block servers. The method includes: the metadata server initiating a data block checking request to the master data block server; the master data block server checking all the data block information managed by the slave data block servers in the group, synchronizing according to the checking result, and then reporting the checking and synchronization results to the metadata server; the metadata server updates the metadata information according to the reported checking and synchronization results. Therefore, the metadata server only takes very little time to fulfill the checking and synchronizing the database.

### TECHNICAL FIELD

The present invention relates to the field of data storage, and more particularly, to a method and apparatus for checking and synchronizing data blocks in a distributed file system.

### BACKGROUND OF THE RELATED ART

With the rapid development of a multimedia industry, more and more manufacturers choose to deploy self-developed distributed storage systems in their products due to the cost, reliability, and many other considerations, therefore, the distributed file system has been rapidly developed.

In the existing distributed file system architecture, a file is generally divided into a plurality of data blocks for storage; to ensure the robustness and disaster recovery capability of the system, the data blocks general have a plurality of backups stored in different physical positions. Thus, there is an issue of checking and synchronizing these data blocks, so as to guarantee the consistency of these data blocks, that is, guarantee that the valid data stored in the data blocks are the same. In the existing framework of the distributed file system, the checking and synchronizing these data blocks is initiated and carried out by a metadata server. If the data blocks reach a certain number, the metadata server has to waste a lot of time in the checking and synchronization of the data blocks, which affects the response speed of the user operation, and further affects the system performance. In particular, in a system such as an interactive internet protocol TV (IPTV) that has a relatively high requirements for real time and user experience, the metadata server has to spend a lot of time in the checking and synchronization of the data blocks, which will seriously affect the response speed of the user operation as well as the system performance.

### CONTENT OF THE INVENTION

The purpose of the present invention is to provide a method and apparatus for checking and synchronizing data blocks in a distributed file system to address the problem that the response speed of the user operation is seriously affected since the metadata server in the distributed file system wastes a lot of time in checking and synchronizing the data blocks in the related art.

The present invention is implemented with, a method for checking and synchronizing the data blocks in the distributed file system, where the distributed file system comprises a metadata server and data block servers; and the method comprises: the metadata server specifying one of the data block servers in a same group as a master data block server, and the other data block servers as slave data block servers, wherein, the method further comprises:

the metadata server initiating a data block checking request to the master data block server;

the master data block server checking all data block information managed by the slave data block servers in the group of the master data block server, synchronizing according to a checking result, and then reporting the checking result and a synchronization result to the metadata server;

the metadata server updating metadata information according to the reported checking and synchronization results.

In the method, the process of the master data block server checking all the data block information managed by the slave data block servers in the group of the master data block server is:

the master data block server sending data block collection requests to the slave data block servers in the group;

the slave data block servers reporting the data block information managed by the slave data block servers to the master data block server;

after the master data block server receives the data block information reported by all the slave data block servers in the group, checking the data blocks.

In the method, before the step of the master data block server sending the data block collection requests to the slave data block servers in the group, the method further comprises: the master data block server acquiring information of all the data block servers in the group from the data block checking request sent by the metadata server.

In the method, after the slave data block servers report the data block information managed by the slave data block servers to the master data block server, the master data block server recording the reported data block information to a buffer.

In the method, the checking is to check a consistency of the master data block and the slave data blocks.

In the method, content to be checked is sizes and version numbers of the data blocks.

In the method, the synchronizing according to the checking result is: synchronizing an inconsistent part in the master data block and the slave data blocks according to the checking result.

In the method, the process of the metadata server initiating a data block checking request to the master data block server is initiated by triggering the metadata server by a timer.

Another purpose of the present invention is to provide an apparatus for checking and synchronizing data blocks in a distributed file system, wherein the distributed file system comprises a metadata server and data block servers; and the metadata server specifies one of the data block servers in a same group as a master data block server, and takes the other data block servers as slave data block servers; wherein, the apparatus comprises:

a checking initiation unit, adapted for initiating a data block checking request to the master data block server;

a checking and synchronization unit, adapted for checking all data block information managed by the slave data block servers in the group of the master data block server, and synchronizing master and slave data blocks according to a checking result, and then reporting the checking result and a synchronization result to the metadata server;

a metadata information update unit, adapted for updating metadata information according to the reported checking and synchronization results.

In the method, the checking and synchronization unit comprises: a data block information collection sub-unit, adapted for sending data block collection requests to the slave data block servers in the group of the master data block server, and initiating data block checking after receiving the data block information managed and reported by all the slave data block servers.

The beneficial effect of the present invention is: only very small amount of the process are processed by the metadata server in the process of checking and synchronizing the data blocks, which only occupies very little time of the metadata server, thus guaranteeing the response speed of the metadata server to the user instruction as well as the system performance.

### BRIEF DESCRIPTION OF DRAWINGS

FIG. 1 is a structural diagram of a distributed file system provided in the related art;

FIG. 2 is a flow chart of a method for checking and synchronizing data blocks in a distributed file system in accordance with an embodiment of the present invention;

FIG. 3 is a flow chart of a specific method for checking and synchronizing data blocks in a distributed file system in accordance with an embodiment of the present invention; and

FIG. 4 is a structural diagram of an apparatus for checking and synchronizing data blocks in a distributed file system in accordance with an embodiment of the present invention.

### PREFERRED EMBODIMENTS OF THE PRESENT INVENTION

In order to more clearly understand the purpose, technical scheme and advantages of the present invention, the present invention will be illustrated in further detail in combination with the accompanying drawings and embodiments in the following. It should be understood that the specific embodiments described herein is only used to explain the present invention rather than to restrict the present invention.

In the embodiments of the present invention, after the metadata server initiates a process of checking and synchronizing the data blocks, the metadata server specifies one data block server in a group of data block servers as a master data block server, the master data block server collects data block information within the group and completes the process of checking and synchronizing, and then reports the result to the metadata server. Thus, the whole process of checking and synchronizing the data blocks only takes a very small amount of time of the metadata server, thereby guaranteeing the response speed of user instructions and the system performance.

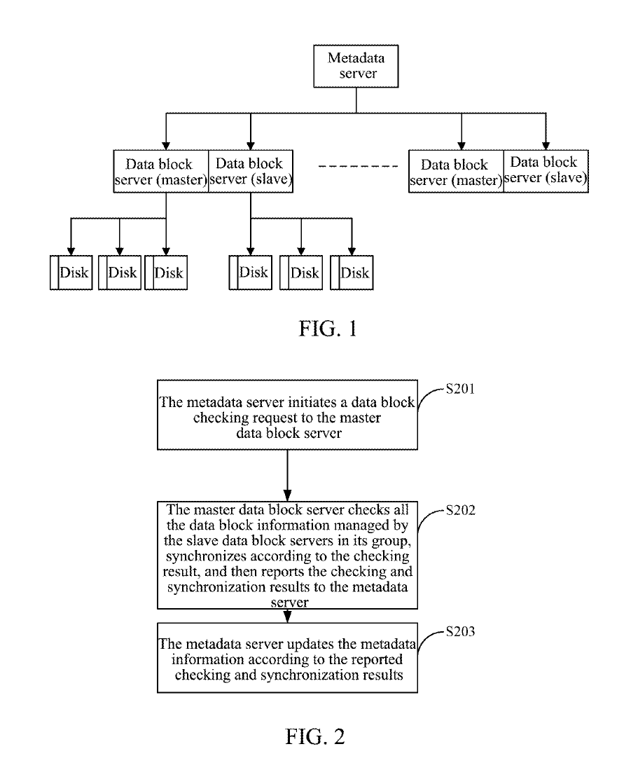

FIG. 1 is a structural diagram of a distributed file system in the related art. The distributed file system comprises the metadata server, data block servers and disks as the storage mediums. The metadata server specifies one data block server in the same group of data block servers as the master data block server, and specifies the other data block servers as the slave data block servers. The data blocks stored in the storage mediums managed by the master data block server are master data blocks, while the data blocks stored in the storage mediums managed by the slave data block servers are slave data blocks. The functions of each part in the system is as follows.

The metadata server is responsible for managing metadata information, such as file names of all the files, data blocks, and a corresponding relationship between the files and the data blocks, and so on; and providing an interface for operations such as metadata write-in and query and so on to a file accessing client.

The data block servers are responsible for interacting with the storage mediums in the local node to read and write the actual data blocks; managing the data block information stored in the storage mediums; responding a data reading and writing request of the file accessing client, reading data from the storage mediums and returning the data to the file accessing client; and reading data from the file accessing client and writing them into the storage mediums.

Data block checking is: checking the consistency of the master data blocks and the slave data blocks, and the main checking contents are the sizes and version numbers of the data blocks.

Data block synchronization is: synchronizing the data blocks that are checked as inconsistent, and the synchronization method mainly is full or partial duplication of the data blocks.

FIG. 2 is a flow chart of a method for checking and synchronizing data blocks in a distributed file system in accordance with an embodiment of the present invention. When the method is used in the above-mentioned distributed file system, the metadata server needs to specify one data block server in the same group of data block servers as the master data block server at the beginning of checking. The method comprises the following steps:

in step S201, the metadata server initiates a data block checking request to the master data block server;

in step S202, the master data block server checks all data block information managed by the slave data block servers within the group, synchronizes according to the checking result, and then reports the checking result and synchronization result to the metadata server;

in step S203, the metadata server updates the corresponding data block metadata information according to the results reported by the master data block server.

Thus, in the process of checking and synchronizing the data block information, the metadata server only initiates the checking request and updates the metadata information according to the checking result. The work to be done by the metadata server is very little and simple, thus the resources consumed by the metadata server are also very little. Therefore, the metadata server can complete the checking of the data blocks while not affect other services, that is to say, it can totally and well guarantee that, at the time of checking the data blocks, the response speed of the user instructions or other performances are not interrupted.

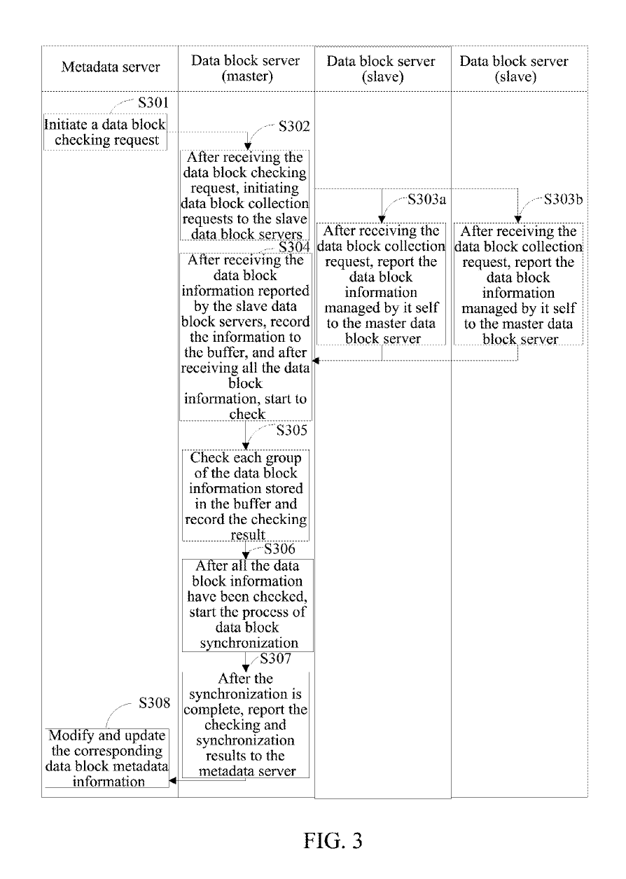

FIG. 3 is a flow chart of a specific method for checking and synchronizing data blocks in a distributed file system in accordance with an embodiment of the present invention. The metadata server is triggered by a timer of data block checking and synchronization to start the process of data block checking; the metadata server constructs the master-slave relationship table of all the disks as the storage mediums in the distributed file system; after the disk master-slave relationship table is constructed completely, the metadata server specifies the data block server, in which the master disk from a master-slave disk group is located, as the master data block server. The specific method process is as follows:

in step S301, the metadata server initiates a data block checking request to the master data block server.

In step S302, after the master data block server receives the data block checking request, it initiates data block collection requests to the slave data block servers corresponding to the master data block server.

After the master data block server receives the data block checking request sent by the metadata server, it starts to initiate the data block checking process in the local group.

The master data block server acquires the information of all the data block servers in the group from the data block checking request information sent by the metadata server, and sends the data block collection request to each slave data block server in the group.

In step S303, after each slave data block server receives the data block collection request, it reports the data block information managed by it self to the master data block server.

Those skilled in the art should understand that there can be a plurality of slave data block servers which are in the same group with the master data block server. To simplify the description, only two slave data block servers are illustrated in FIG. 3.

In step S304, after the master data block server receives the data block information reported by the slave data block servers, the master data block server records the information to the buffer, and after receiving all the data block information reported by all the slave data block servers, starts to check the data blocks.

In step S305, the master data block server checks each group of the data block information stored in the buffer and records the checking result.

The checking is mainly to check the sizes and version numbers of the data blocks.

In step S306, after all the data block information have been checked, the master data block server starts the process of data block synchronization.

The master data block server synchronizes the inconsistent part in the master and slave data blocks according to the checking result, and the practical synchronization process might relate to operations such as the duplication of the data blocks and so on.

In step S307, after the synchronization of all the data block that need to be synchronized is complete, the master data block server fulfills the process of data block checking and synchronization and reports the checking and synchronization result to the metadata server;

in step S308, the metadata server modifies and updates the corresponding data block metadata information according to the checking and synchronization result reported by each master data block server.

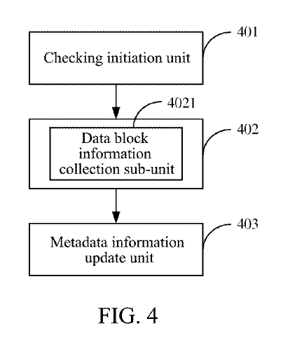

FIG. 4 is a structural diagram of an apparatus for checking and synchronizing data blocks in a distributed file system in accordance with an embodiment of the present invention. To simplify the description, here only the part relevant to the invention is illustrated. The specific structure of the distributed file system is as above description. The apparatus structure comprises:

a checking initiation unit 401, used to initiate a data block checking request to the master data block server; the specific process is described as above;

a checking and synchronization unit 402, used to check all the data block information managed by the slave data block servers which are in the same group with the master data block server, and to synchronize the master and slave data blocks according to the checking result, and then to report the checking and synchronization result to the metadata server; the specific process is described as above;

a metadata information update unit 403, used to update the metadata information according to the reported checking and synchronization result; the specific process is described as above.

The checking and synchronization unit 402 comprises a data block information collection sub-unit 4021. The data block information collection sub-unit 4021 is used to send a data block collection request to the slave data block servers which are in the same group with the master data block server, and initiate the data block checking after receiving the data block information managed and reported by all the slave data block servers; the specific process is described as above.

In the embodiments of the present invention, the burden of the metadata server can be reduced since the master data block server fulfills the process of checking and synchronizing the data blocks; the master data block server collects and then checks the data block information of the slave data block servers, thus fastening the checking speed; the master data block server acquires the information of all the data block servers in the group from the data block checking request sent by the metadata server, which can acquire the correct information of the data block servers in the group in real time; and the master data block server records the reported data block information in the buffer, so as to facilitate for the centralized checking.

The above description is only the preferred embodiments of the present invention, and is not intended to limit the present invention. All modifications, equivalents and variations, which are made without departing from the spirit and essence of the present invention, should belong to the scope of the present invention.

1. A method for checking and synchronizing data blocks in a distributed file system, wherein the distributed file system comprises a metadata server and data block servers; and the method comprises: the metadata server specifying one of the data block servers in a same group as a master data block server, and the other data block servers as slave data block servers, wherein, the method further comprises:
the metadata server initiating a data block checking request to the master data block server;
the master data block server checking all data block information managed by the slave data block servers in the group of the master data block server, synchronizing according to a checking result, and then reporting the checking result and a synchronization result to the metadata server;
the metadata server updating metadata information according to the reported checking and synchronization results.

2. The method of claim 1, wherein, the process of the master data block server checking all the data block information managed by the slave data block servers in the group of the master data block server is:
the master data block server sending data block collection requests to the slave data block servers in the group;
the slave data block servers reporting the data block information managed by the slave data block servers to the master data block server;
after the master data block server receives the data block information reported by all the slave data block servers in the group, checking the data blocks.

3. The method of claim 2, wherein, before the step of the master data block server sending the data block collection requests to the slave data block servers in the group, the method further comprises: the master data block server acquiring information of all the data block servers in the group from the data block checking request sent by the metadata server.

4. The method of claim 2, wherein, after the slave data block servers report the data block information managed by the slave data block servers to the master data block server, the master data block server recording the reported data block information to a buffer.

5. The method of claim 1, wherein, the checking is to check a consistency of the master data block and the slave data blocks.

6. The method of claim 5, wherein, content to be checked is sizes and version numbers of the data blocks.

7. The method of claim 1, wherein, the synchronizing according to the checking result is: synchronizing an inconsistent part in the master data block and the slave data blocks according to the checking result.

8. The method of claim 1, wherein the process of the metadata server initiating a data block checking request to the master data block server is initiated by triggering the metadata server by a timer.

9. An apparatus for checking and synchronizing data blocks in a distributed file system, wherein the distributed file system comprises a metadata server and data block servers; and the metadata server specifies one of the data block servers in a same group as a master data block server, and takes the other data block servers as slave data block servers; wherein, the apparatus comprises:
a checking initiation unit, adapted for initiating a data block checking request to the master data block server;
a checking and synchronization unit, adapted for checking all data block information managed by the slave data block servers in the group of the master data block server, and synchronizing master and slave data blocks according to a checking result, and then reporting the checking result and a synchronization result to the metadata server;
a metadata information update unit, adapted for updating metadata information according to the reported checking and synchronization results.

10. The apparatus of claim 9, wherein, the checking and synchronization unit comprises:
a data block information collection sub-unit, adapted for sending data block collection requests to the slave data block servers in the group of the master data block server, and initiating data block checking after receiving the data block information managed and reported by all the slave data block servers.

11. The method of claim 2, wherein, the checking is to check a consistency of the master data block and the slave data blocks.

12. The method of claim 3, wherein, the checking is to check a consistency of the master data block and the slave data blocks.

13. The method of claim 4, wherein, the checking is to check a consistency of the master data block and the slave data blocks.

14. The method of claim 2, wherein, the synchronizing according to the checking result is: synchronizing an inconsistent part in the master data block and the slave data blocks according to the checking result.

15. The method of claim 3, wherein, the synchronizing according to the checking result is: synchronizing an inconsistent part in the master data block and the slave data blocks according to the checking result.

16. The method of claim 4, wherein, the synchronizing according to the checking result is: synchronizing an inconsistent part in the master data block and the slave data blocks according to the checking result.

17. The method of claim 2, wherein the process of the metadata server initiating a data block checking request to the master data block server is initiated by triggering the metadata server by a timer.

18. The method of claim 3, wherein the process of the metadata server initiating a data block checking request to the master data block server is initiated by triggering the metadata server by a timer.

19. The method of claim 4, wherein the process of the metadata server initiating a data block checking request to the master data block server is initiated by triggering the metadata server by a timer.
